(19) United States
(12) Patent Application Publication
(10) Pub. No.: US 2004/0174242 A1
(43) Pub. Date: Sep. 9, 2004

(54) Inductively coupled plasma load coil

(76) Inventor: Mark D. Kuehn, Sandy, UT (US)

Correspondence Address: R. Neil Sudol, 714 Colorado Avenue, Bridgeport, CT, 06605-1601, US

(21) Appl. No.: 10/790,349

(22) Filed: Mar. 1, 2004

Related U.S. Application Data
(60) Provisional application No. 60/451,471, filed on Mar. 3, 2003.

(51) Int. Cl. H01F 27/28

(52) U.S. Cl. 336/200

(57) ABSTRACT

A copper coil used to induce plasma in spectroscopy and other associated fields is electroplated with nickel, platinum, palladium, rhodium, ruthenium, or other appropriate metal to act as a barrier to the migration of copper atoms. This barrier layer is further electroplated with a layer of gold, platinum, palladium, rhodium, or ruthenium. This second layer is added to provide resistance to oxidation of the barrier layer and of the copper coil.

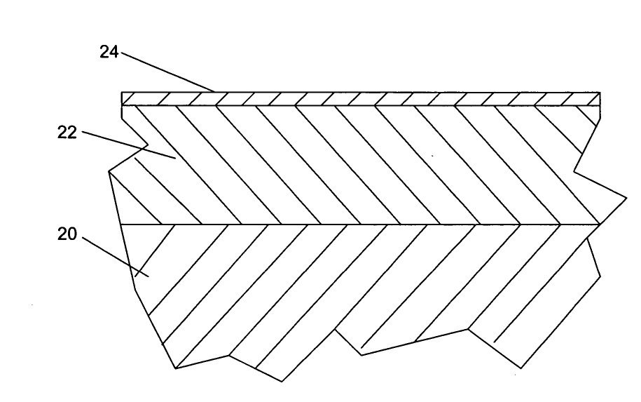

### CROSS-REFERENCE TO RELATED APPLICATION

This application claims the benefit of U.S. Provisional Patent Application No. 60/451,471 filed Mar. 3, 2003.

### BACKGROUND OF THE INVENTION

This invention relates to radio frequency and microwave frequency induction load coils typically used in inductively coupled plasma optical emission spectroscopy and inductively coupled plasma mass spectroscopy as well as analogous applications of such load coils.

Inductively coupled plasma optical emission spectroscopy (ICP-OES) and inductively coupled plasma mass spectroscopy (ICP-MS) have used simple copper capillary tubing load coils from the beginning. These coils are simply a radio frequency (RF) antennae used to induce a plasma (ionized gas) in an argon gas contained inside a quartz torch (tube). A photo of such a coil may be found the World Wide Web site noblecoil.com.

An induction load coil in any of several various shapes is common to all inductively coupled plasma emission or mass spectrometers. The high-temperature plasma is used to excite an aqueous solution containing ions of analytical interest. This solution is injected into the center of the plasma where the solution is excited by the plasma and is quantified by quantized light emission or directly as isotopes of the elements of interest.

The ICP-OES and ICP-MS induction load coils are exposed to high heat, intense ultraviolet radiation, and strong oxidizing conditions. Under these extreme conditions the copper material of the coils readily oxidizes and scales off, exposing unoxidized copper underneath. The newly exposed copper metal is also readily oxidized. This process of physical degradation continues until the coil is removed from service or until the degradation leads to an ionized discharge from the coil to the quartz torch confining the plasma. This undesired event usually results in the destruction of the coil as well as the quartz torch. These parts are expensive and the repair requires several hours to return the instrument to operation. In addition to the progressive physical degradation of the copper load coil, the coupling function of the coil is also degraded. For these reasons conventional copper load coils must be replaced at frequent intervals, usually between every three months and every six months, depending on usage. As such, these coils have traditionally been thought of as consumables. In addition to the expense of replacing the coil are the expense of servicing the instrument when these coils ultimately fail, and the cost of replacing other parts, such as quartz torches, often damaged when these coils fail catastrophically. As the copper coils degrade over time, the efficiency of the coils is decreased leading to a loss of analytical sensitivity.

This problem has existed since the development of ICP-MS and ICP-OES ten and twenty years ago respectively. Glass Expansion, an Australian company, markets two after-market replacement coils designed for an extended life. One is a conventional copper coil electroplated with silver, the other is a copper coil electroplated with a layer of silver and then a layer of gold. Glass Expansion states that the silver coil offers a 25% improvement in life and that the silver and gold combination coil offers a 50% improvement in life. These improvements are however only marginally better than the conventional copper coil sold by the instrument manufacturers. Due to the rapid migration of copper atoms through the silver and gold to the surface of the coil, surface oxidation and scaling continues to be a source of physical degradation, diminishing plasma coupling efficiency and leading to ultimate failure, albeit at a slightly slower rate than the conventional copper coil.

Thus, the market has provided no RF or MF coil that adequately solves the problem of coil degradation, drop in analytical sensitivity, and damage to the instrument upon the failure of the coil due to oxidation of copper at the surface.

### OBJECTS OF THE INVENTION

An object of the present invention is to provide an improved inductively coupled load coil of the above-described type.

A further object of the present invention is to provide such a load coil having a substantially increased operational life, enhanced instrument performance throughout the life of the load coil, and a reduced likelihood of damage to the load coil and other parts.

Another object of the present invention is to provide such a load coil wherein surface oxidation of the load coil is substantially reduced, if not entirely eliminated.

These and other objects of the present invention will be apparent to those skilled in the art from the drawings and descriptions herein. Although every object of the invention is attained by at least one embodiment of the invention, there is not necessarily any one embodiment that achieves all of the objects of the invention.

### SUMMARY OF THE INVENTION

An improved radio frequency (RF) or microwave frequency (MF) load coil in accordance with the present invention comprises a conventional primary copper capillary tubing coil, first electroplated with a metal that acts as a barrier to the migration of copper to an overlying electroplated noble metal layer. Metals preferred for the barrier layer are certain transition (Group VIII) metals, namely, nickel, platinum, palladium, rhodium, and ruthenium. The noble metal protects the barrier layer and the conventional copper coil from oxidation, physical degradation (scaling), and performance degradation. The noble metals suitable for the surface electroplated layer are gold, platinum, palladium, rhodium, and ruthenium. Preferably, gold is used as the outer or surface layer.

Purity of the noble metal or combination of noble metals must exceed 99.5% in the surface layer, to prevent hysterisis in the surface layer. In other words, no metal or combination of metals other than the noble metals listed above may constitute more than 0.5% of the surface layer.

In the case of the platinum group metals (PGMs) platinum, palladium, rhodium, and ruthenium, a single electroplated layer may be substituted for the two-layer coil described above. This is possible because the unique qualities of the PGMs result in both a barrier to copper atom migration and sufficient nobility to resist oxidation of the copper coil.

A copper inductive load coil provided with a PGM coating or layer in accordance with the present invention has a dramatically extended life expectancy. This reduces the expense of replacing the coil and repairing any damaged instrumentation. Additionally, the optimal performance of the coil is maintained for the greatly extended life of the coil.

### BRIEF DESCRIPTION OF THE DRAWING

The sole FIGURE of the drawing is a transverse cross-sectional view of a copper load coil with two layers or coatings in accordance with the present invention.

### DETAILED DESCRIPTION OF THE PREFERRED EMBODIMENTS

The copper coil 20 of the kind conventionally used in inductively coupled plasma optical emission spectroscopy (ICP-OES) or inductively coupled plasma mass spectroscopy (ICP-MS) is provided with an electroplated inner coating or layer 22 of a metal that acts as a barrier to the migration of copper atoms outwardly from the tubing of coil 20. Preferred metals for this barrier layer 22 are certain transition (Group VIII) metals, namely, nickel, rhodium, platinum, palladium, and ruthenium or any alloy of these metals in any proportion. These metals or combination of metals must be plated in sufficient purity to provide an adequate barrier to copper atom migration. These transition (Group VIII) metals may be plated onto coil 20 from a sulfate, chloride, sulfamate, cyanide, or other suitable bath. Layer 22 has a thickness consistent with normal practice in the electroplating arts. That is, thick enough to provide a complete and continuous surface but not so thick that internal stresses cause cracking. This is a normal function of the electroplating arts and does not constitute a part of the present invention. A thickness of 1000 microns is generally satisfactory. Normal surface cleaning and preparation familiar to anyone skilled in the electroplating arts would be observed.

Over the barrier layer 22, an outer or surface layer 24 is electroplated. This outer or surface layer 24 must be one of the noble metals, that is, gold, platinum, palladium, rhodium, or ruthenium or any alloy of these metals in any proportion. However, the purity of this second layer or surface layer must be greater than 99.5% for any one or combination of the noble metals listed. That is, no other metal or metals, other than the noble metals listed may in any combination exceed 0.5%. This is essential to prevent the surface layer from being subject to oxidation. A preferred noble metal for layer 24 is substantially pure gold.

In the case of the platinum group metals (PGMs), platinum, palladium, rhodium, and ruthenium a single electroplated layer may be substituted. This is because of the unique properties of these metals. They provide a barrier to the migration of copper atoms and are sufficiently noble to resist oxidation. This single layer (not shown) may be any single PGM or any alloy of these metals as long as singly or in the aggregate they constitute greater than 99.5% of the single layer. In addition, no adulterating metal or combination of adulterating metals may exceed 0.5% of this single layer. This is critical to provide both a barrier to copper atom migration and to maintain the resistance to oxidation.

The operation and use of the invention is exactly the same as the conventional copper load coil. It may be installed on the instrument by the same means as used for the conventional coil. The only operational difference is a greatly extended service life. The operator may notice that the invention maintains optimal plasma coupling throughout this greatly extended life.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. An inductively coupled plasma load coil, comprising:
a coiled copper capillary tube;
an inner layer of a transition metal coating said tube; and
an outer layer of a noble metal plated onto said inner layer, said noble metal being different from said transition metal.

2. The load coil defined in claim 1 wherein said transition metal is taken from the group consisting of nickel, platinum, palladium, rhodium, and ruthenium

3. The load coil defined in claim 2 wherein said transition metal is nickel.

4. The load coil defined in claim 3 wherein said noble metal is gold.

5. The load coil defined in claim 4 wherein said gold is substantially pure.

6. The coil defined in claim 5 wherein said gold is at least 99.5% pure.

7. The load coil defined in claim 6 wherein said inner layer is substantially thicker than said outer layer.

8. The load coil defined in claim 7 wherein said inner layer is about ten times as thick as said outer layer.

9. The load coil defined in claim 7 wherein said inner layer is about 1000 microns thick and said outer layer is about 10 microns thick.

10. An inductively coupled plasma load coil, comprising:
a coiled copper capillary tube;
an outer layer of a noble metal electroplated onto said capillary tube; and
an electroplated inner layer of a material for at least substantially impeding a migration of copper from said tube to said outer layer of said noble metal, the material of said inner layer being different from said noble metal.

11. The load coil defined in claim 10 wherein said material of said inner layer comprises a transition metal.

12. The load coil defined in claim 11 wherein said transition metal is taken from the group consisting of nickel, platinum, palladium, rhodium, and ruthenium

13. The load coil defined in claim 12 wherein said transition metal is nickel.

14. The load coil defined in claim 12 wherein said noble metal is gold.
